(19) United States
(12) Patent Application Publication
(10) Pub. No.: US 2015/0213418 A1
(43) Pub. Date: Jul. 30, 2015

(54) ACH PAYMENT AUTHENTICATION SYSTEM AND METHOD

(71) Applicant: THE BANK OF NEW YORK MELLON, New York, NY (US)

(72) Inventors: Cheryl GURZ, New York, NY (US); Paul SIMONS, New York, NY (US)

(21) Appl. No.: 14/607,476

(22) Filed: Jan. 28, 2015

Related U.S. Application Data
(60) Provisional application No. 61/933,146, filed on Jan. 29, 2014.

(51) Int. Cl. G06Q 20/02; G06Q 20/40

(52) U.S. Cl. CPC G06Q 20/023; G06Q 20/40

(57) ABSTRACT

A system for verifying ACH data for a proposed ACH transaction includes one or more computer processors, at an ACH transaction verifier, configured to execute one or more computer program modules configured to: receive, via the one or more processors, account locator information and verification information; query, via the one or more processors, an ACH transaction database at an ACH transaction processing system with the account locator information to obtain prior transaction data associated with the account locator information; compare, via the one or more processors, the verification information with the prior transaction data; and determine, via the one or more processors, a verification of the account locator information based on the comparing. Associated systems and methods are also disclosed.

This application claims priority of U.S. Provisional Application No. 61/933,146, filed on Jan. 29, 2014, entitled “ACH PAYMENT AUTHENTICATION SYSTEM AND METHOD,” the entire contents of which is incorporated herein by reference in its entirety.

### BACKGROUND

This application is directed to computer-implemented systems and methods useful for authentication of Automated Clearing House (ACH) payment transactions.

Conventionally, ACH transactions are authenticated on a bank-by-bank basis, and on a periodic basis (e.g., not real time). For example, when an ACH transaction is submitted, utilizing an American Banking Association (ABA) number and an account number as printed on a check, the ACH payment is routed (e.g., next day) to the bank identified by the ABA number, and the transaction is credited or debited to the account at the bank identified by the account number. As such, there is limited ability at the point of submitting the ACH transaction to validate certain account information, such as verification that the submitted account number corresponds to an actual account at the bank, or that it matches other information submitted with the ACH transaction, such as an account owner's name or authorized user's name.

### SUMMARY

Various embodiments of this disclosure may be used in conjunction with existing financial services platforms and utilities, of which features thereof may be found in U.S. Pat. No. 7,398,249, incorporated herein by reference in its entirety.

According to an embodiment, a system for verifying ACH data for a proposed ACH transaction includes one or more computer processors at an ACH transaction verifier. The one or more computer processors are configured to execute one or more computer program modules. The program modules are configured to receive, via the one or more processors, account locator information and verification information. The program modules are also configured to query, via the one or more processors, an ACH transaction database at an ACH transaction processing system with the account locator information to obtain prior transaction data associated with the account locator information. The program modules are additionally configured to compare, via the one or more processors, the verification information with the prior transaction data. The program modules are further configured to determine, via the one or more processors, a verification of the account locator information based on the comparing.

According to another embodiment, a computer implemented method for verifying ACH data for a proposed ACH transaction, wherein the method is implemented in a computer system comprising one or more processors configured to execute one or more computer program modules, includes receiving, via the one or more processors, account locator information and verification information. The method also includes querying, via the one or more processors, an ACH transaction database at an ACH transaction processing system with the account locator information to obtain prior transaction data associated with the account locator information. The method additionally includes comparing, via the one or more processors, the verification information with the prior transaction data. The method further includes determining, via the one or more processors, a verification of the account locator information based on the comparing.

The system and method of this disclosure provides various capabilities as discussed more fully in the detailed description below.

### BRIEF DISCUSSION OF THE DRAWINGS

FIG. 1 illustrates a schematic embodiment of a system for verifying ACH data for a submitted transaction;

FIG. 2 illustrates an embodiment of a process and data flowchart implemented on the system of FIG. 1;

FIG. 3 illustrates an embodiment of a method of verifying ACH data for a submitted transaction;

FIG. 4 illustrates an exemplary computer system configured to perform the functions of systems and methods described herein; and

FIG. 5 illustrates another embodiment of a system configured to perform the functions of systems and methods described herein.

### DETAILED DESCRIPTION

In the discussion of various embodiments and aspects of the system and method of this disclosure, examples of the processors described herein may include those processors implemented in any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to verify ACH data. This description is not intended to be limiting, but is merely provided to describe ways of accomplishing the functions associated with verifying submitted ACH transactions (e.g., e-check payments) at their point of submission.

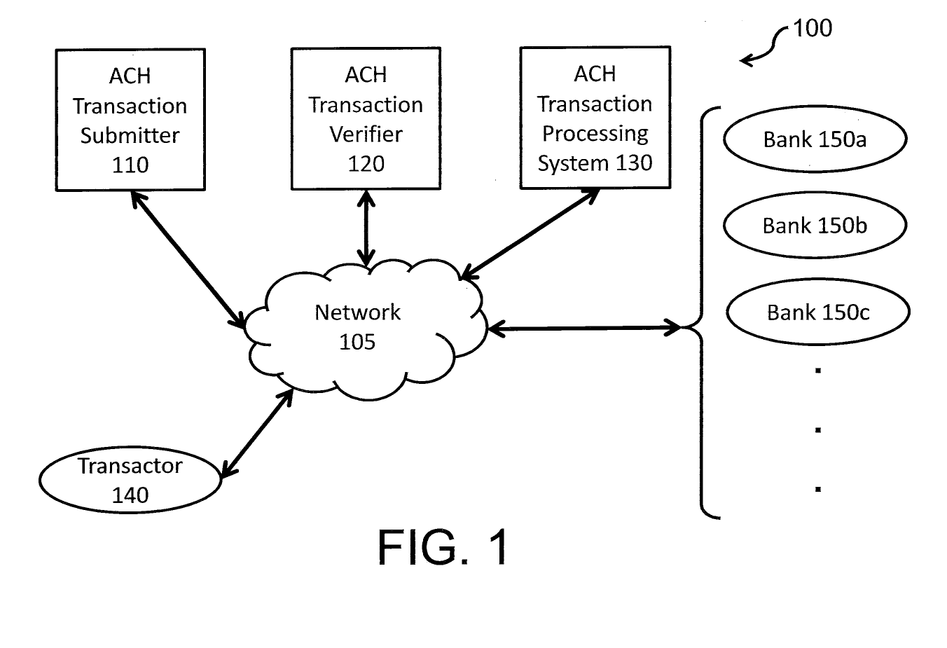

FIG. 1 schematically illustrates a networked relationship 100 comprising a network 105 operatively linked between an ACH transaction submitter 110, an ACH transaction verifier 120, and one or more ACH transaction processing systems 130. In an embodiment, the ACH transaction submitter 110 may comprise a system comprising one or more processors configured to submit ACH transactions for payment. As an example, the ACH transaction submitter 110 may comprise any computer system that is configured to accept payments from a transactor 140 made via ACH. In an embodiment, the transactor 140 may comprise a computer system accessible by an account holder. In an embodiment, the transactor 140 and the ACH transaction submitter 110 may be arranged in a client/server relationship, where the transactor 140 is configured to submit data to the ACH transaction submitter 110, which itself is configured to receive the data. In various embodiments, the ACH transaction submitter 110 may comprise one or more computer systems at retailers or banks, for example, which may receive the data from the transactor 140 so as to submit the data for a transaction with or by a user at the transactor 140. Where conventionally an ACH payment may be submitted to the ACH transaction processing system 130 for routing to a bank 150 (e.g., computer systems thereat) associated with the ABA number, in an embodiment the ACH payment may initially be submitted to the ACH transaction verifier 120 (i.e., one or more processors thereof) for verification, as described in greater detail below. In various embodiments, the bank 150 may comprise one or more computer systems therein associated with accounts that may be accessed via the ACH transaction data, or otherwise may receive ACH transaction requests for processing on accounts associated therewith. In an embodiment, once the ACH transaction is verified by the ACH transaction verifier 120, the ACH transaction may be routed to one or more processors of one of the ABA transaction processing systems 130. In an embodiment, the verification may be sent from the ACH transaction verifier 120 back to the ACH transaction submitter 110, and the ACH transaction submitter 110 may subsequently send the ACH transaction to the ACH transaction processing system 130. In an embodiment the verification may be sent from the ACH transaction verifier 120 back to the ACH transaction submitter 110 while the ACH transaction verifier itself submits the ACH transaction to the ACH transaction processing system 130. In still another embodiment, either of the ACH transaction submitter 110 or the ACH transaction verifier 120 may submit the ACH transaction to the bank 150 associated with the ABA number following the verification.

In an embodiment, as described in greater detail below, the ACH transaction processing system 130 may comprise one or more of the Electronics Payments Network (EPN) operated by The Clearing House Payments Company L.L.C. (a/k/a PayCo) and FedACH operated by the Federal Reserve. Additionally or alternatively, other ACH transaction processing systems 130 may be utilized in various embodiments, such as the Expedited Processing and Settlement (EPS) proposal submitted by NACHA—The Electronic Payments Association. In various embodiments, a plurality of ACH transaction processing systems 130 may have agreements with one another so that one ACH transaction processing system 130 may process some transactions for another ACH transaction processing system 130 when either party to a transaction is not their own customer. In an embodiment, interoperator transactions may be settled by the Federal Reserve Banks.

As noted above, the processes and actions described herein may be implemented over the common network 105. As shown in FIG. 1, for example, each of the transactor 140, the ACH transaction submitter 110, the ACH transaction verifier 120, the ACH transaction processing system 130, and the bank(s) 150 may be linked through the common network 105, which may include one or more local networks and/or wide area networks (including but not limited to the Internet) therein. It may be appreciated that in some embodiments portions of the network 105 may be disconnected from other portions of the network, such that one system might not be directly linked to another system, but may access that system indirectly through submission to an intermediate system that does have a networked relationship with the ultimate recipient. Accordingly, as described in greater detail herein, in an embodiment the transactor 140 may utilize a portion of the network 105 to relay ACH information to the ACH transaction submitter 110. The ACH transaction submitter 110 may then utilize a portion of the network 105 to relay the ACH information to the ACH transaction verifier 120. The ACH transaction verifier 120 may query a transaction database at the ACH transaction processing system 130 via the network 105, and may determine whether the ACH information ultimately received from the transactor 140 is verified according to prior transaction data received via the network 105 from the ACH transaction processing system 130. In an embodiment, if verified, one of the ACH transaction submitter 110, the ACH transaction verifier 120, and the ACH transaction processing system 130 may utilize the network 105 to relay the ACH information to an associated one of the banks 150 for processing of the ACH transaction.

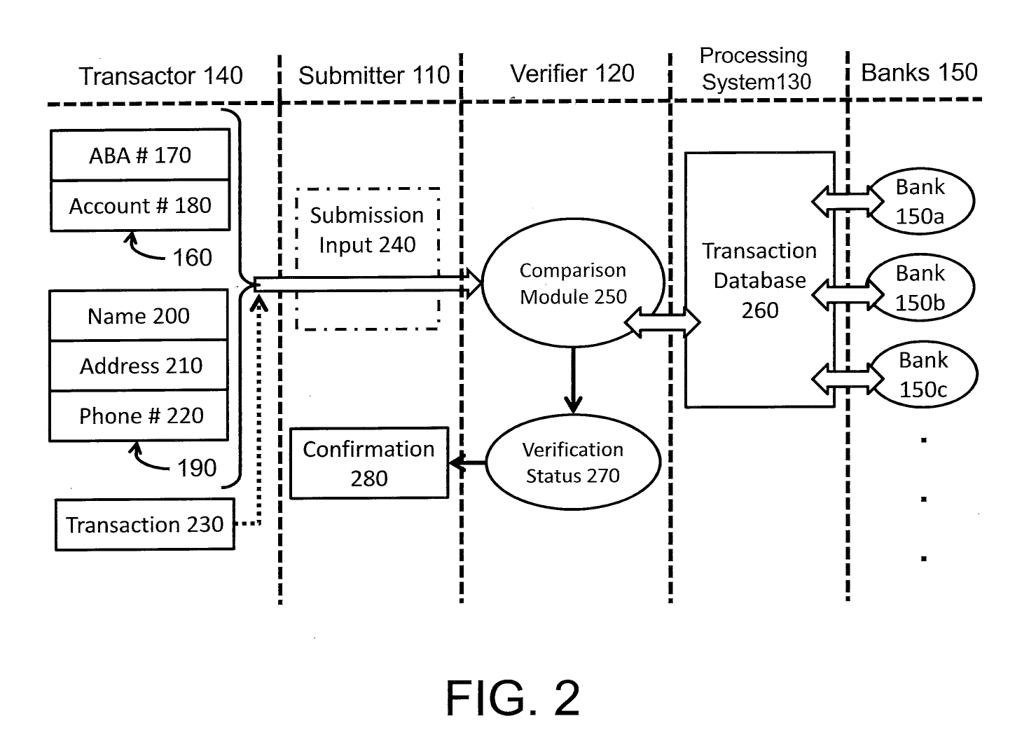

In an embodiment an ACH transaction submitted from the ACH transaction submitter 110 to the ACH transaction verifier 120 may be compared against prior transactions processed by the ACH transaction processing system(s) 130. For example, in an embodiment the ACH transaction verifier 120 may have access to transaction databases associated with the ACH transaction processing system(s) 130, and may query those databases to compare data submitted by the ACH transaction submitter 110 (e.g., received from the transactor 140) with prior transactions matching the ABA number and account number stored in the transaction databases associated with the ACH transaction processing system(s) 130. As shown in FIG. 2, for example, the transactor 140 may provide account locator information 160, including an ABA number 170 and an account number 180, to the ACH transaction submitter 110. The transactor 140 may also provide verification information 190, such as a name 200 (e.g., the account owner name or an authorized user name), an address 210, or a contact phone number 220, which may be used to verify the account locator information 160 at the ACH transaction processing system 130. Other pieces of verification information may include, for example, an e-mail address, a code word, a password, or a personal identification number. Accordingly, the ACH transaction submitter 110 may submit the account locator information 160 and the verification information 190 to the ACH transaction verifier 120.

In an embodiment, the transactor 140 may also submit transaction information 230 (e.g., a credit or debit of a particular dollar amount) to the ACH transaction submitter 110. In an embodiment, the transaction information 230 may be associated with account information for the ACH transaction submitter 110 (e.g., where the transactor 140 is paying the ACH transaction submitter 110 via an ACH transaction) or may be associated with another transactor 140 (e.g., where the ACH transaction submitter 110 is facilitating a transaction between two transactors 140). In an embodiment, the transaction information 230 may be omitted from what is ultimately sent to the ACH transaction verifier 120, as such information might not be utilized to verify the account locator information 160. Instead, in some embodiments, the transaction information 230 may be held by the ACH transaction submitter 110 until the account locator information 160 is verified, before the ACH transaction submitter 110 submits the verified account locator information 160 and the transaction information 230 to the ACH transaction processing system 130 for processing of the payment. In other embodiments, the transaction information 230 may be submitted by the ACH transaction submitter 110 to the ACH transaction verifier 120, so that upon verification, the ACH transaction verifier 120 may submit the verified account locator information 160 and the transaction information 230 to the ACH transaction processing system 130.

As further shown in FIG. 2, in an embodiment the account locator information 160, the verification information 190, and (in some embodiments) the transaction information 230 may be received by the ACH transaction submitter 110 via a submission input module 240. In an embodiment, the submission input module 240 may be configured to interface with a user interface associated therewith, such as a graphical user interface (e.g., over a website or through appropriately programmed software) and/or a text based interface (e.g., a terminal connection). As shown, the account location information 160 and the verification information 190 may be transmitted via the submission input module 240 to the ACH transaction verifier 120. In an embodiment, the account locator information 160 and the verification information 190 may be received in a comparison module 250, described in greater detail below.

It may be appreciated that in an embodiment the ACH transaction verifier 120 may interface with a transaction database 260 at the ACH transaction processing system 130, which itself interfaces with the different banks 150 to process ACH transactions. The ACH transaction verifier 120 may query the transaction database 260 with the ABA number 170 and the account number 180, and receive prior transaction data from the transaction database 260, which may be compared with the verification information 190 provided with the account locator information 160. Accordingly, if data in the account verification information 190 matches analogous data in the prior transaction data received from the transaction database 260 based on prior transactions associated with the ABA number 170 and the account number 180, then the comparison module may indicate a match. In an embodiment, the match may be transmitted to a verification status module 270 aft the ACH transaction verifier 120, which may in turn be relayed to the ACH transaction submitter 110 as a confirmation 280. As discussed above, once verified the ACH transaction submitter 110 may in some embodiments submit the account locator information 160 and the transaction data 230 to the ACH transaction processing system 130 for processing. In other embodiments, the ACH transaction verifier 120 may submit the transaction data 230 to the ACH transaction processing system 130 for processing once verifying the account locator information 160 or (if previously submitted to the ACH transaction processing system 130) may confirm a verification with the ACH transaction processing system 130, to authorize processing of the ACH transaction by the ACH transaction processing system. In an embodiment, the ACH transaction verifier 120 and the ACH transaction processing system 130 may be the same entity, facilitating verification of the account locator information 160 prior to processing the ACH transaction with the banks 150.

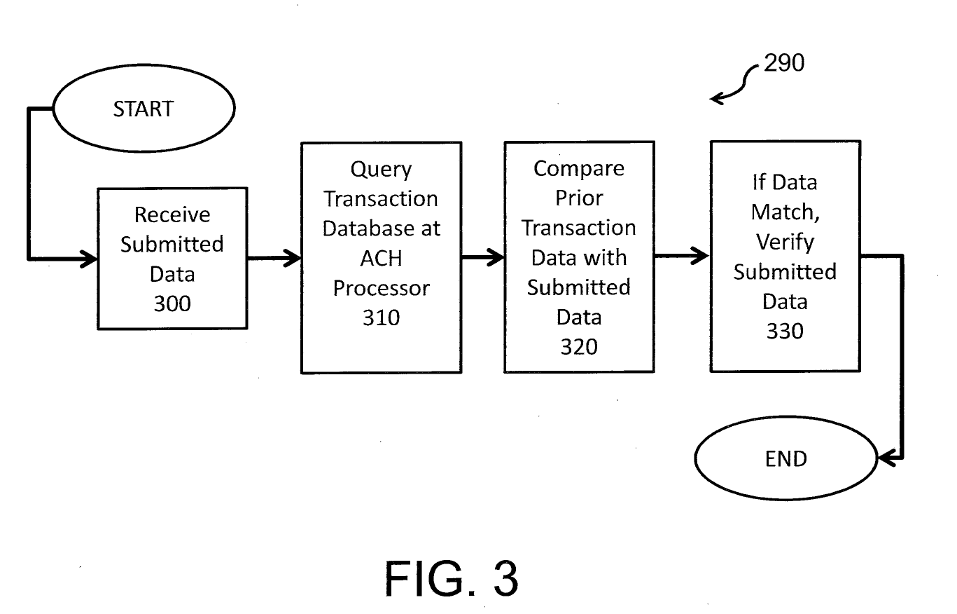

FIG. 3 illustrates an embodiment of a process 290 which may be operated by the comparison module 250. As described below, the comparison modules 250 may be operated on one or more computer processors on one or more associated systems. As shown, the process 290 may include receiving submitted data at 300. It may be appreciated that the submitted data may be received from a transactor such as the transactor 140, or through an ACH transaction submitter, such as the ACH transaction submitter 110. In an embodiment, the submitted data may comprise account locator information, such as an ABA number (e.g., a bank identifier) and an account number associated with an account at the identified bank. The submitted data may also include account verification information, including but not limited to a name that may be the name of the account owner, or the name of an authorized user. Other account identifier information may also be submitted in the submitted data, including but not limited to an address and/or a phone number associated with the account. In an embodiment, the account identifier information may comprise a password or personal identification number.

Having received the submitted data at 300, process 290 may continue at 310 by utilizing the account locator information to query a transaction database at an ACH transaction processing system. In an embodiment, the ACH transaction processing system may be one of the processors who process ACH transactions for banks, routing the transactions to the appropriate banks for clearance at the associated checking accounts, such as those processing systems at The Clearing House or the Federal Reserve. In an embodiment, querying the transaction database at 310 may comprise searching the transaction database for past transactions based on the ABA number 170 and the account number 180, and retrieving prior transaction data for that ABA number 170 and account number 180. In an embodiment, the prior transaction data may comprise one or more of a name associated with the account number 180 at the transaction database, an address associated with the account number 180 at the transaction database, and a phone number associated with the account number 180 at the transaction database. In some embodiments, the prior transaction data may comprise dates of prior ACH transactions.

Upon receiving the prior transaction data from querying the transaction database at 310, process 290 may continue at 320 by comparing the prior transaction data with the account verification information received in the submitted data at 310. In an embodiment, the comparing may be based on an approximation of the account verification information and the prior transaction data. For example, where the account verification information includes an account owner's name (and/or authorized user's name), such data may be compared with an approximation of the analogous data in the prior transaction data (e.g., omitting a middle name/initial, basing the comparison on just the last name, basing the comparison on a first initial and last name, or so on). In an embodiment where at least some of the account verification data matches analogous data (or approximations thereof) in the prior transaction data, a verification of the submitted data may be established at 330. In some embodiments, a likelihood of a match may be computed (e.g., by one or more processors at the ACH transaction verifier 120), in which case determining the verification of the submitted data may be based on the likelihood of the match exceeding a certain threshold amount. For example, in an embodiment the comparison of the submitted data and the prior transaction data may be quantified based on assigned “point” values for certain data points (e.g., last name match, address match, first and/or middle initial of name match, or so on). In an embodiment, certain data points may be weighted as more important than others when computing an overall match likelihood, based on the weighted average of different data points.

In an embodiment, the weighting may vary depending on other conditions associated with the data matching. For example, in an embodiment, the last name matching may be weighted greater than the first name match when an honorific in the submitted data and an honorific in the prior transaction data differ from male to female, which may indicate the presence of an authorized spouse. In an embodiment, first name matching may be weighted greater than last name matching when the honorific is female, which may indicate a last name change due to marriage. In an embodiment, it may be appreciated that data point weightings may be based on standard conventions of probabilities, and might not be dispositive of any name change or family relationship based rationale for verifying the submitted data for an ACH transaction. In an embodiment, once a likelihood is computed, the ACH transaction verifier may compare the likelihood against a threshold for verification. In an embodiment, being above a certain percentage likelihood of a match (e.g., greater than or equal to 80%) may trigger a verification of match, while being below a certain likelihood of match (e.g., less than or equal to 30%) may trigger a rejection of the submitted data. In an embodiment, an intermediate range (e.g., between 30% and 80% exclusive in an embodiment) may trigger a referral for authorization to proceed with the transaction, or may advance the submitted data for further analysis and attempted verification.

In an embodiment, the further analysis may include obtaining past check images from one or more check databases (e.g., at the ACH transaction processing system) to view alternate names listed on the face of the check, or to view signatures associated therewith. In an embodiment, Optical Character Recognition (OCR) of typed information on the check image may facilitate automated verification, while in some embodiments the information may be presented to users at the ACH transaction verifier (e.g., employees utilizing the systems thereof) for manual verification. In an embodiment, the ACH transaction verifier may query wire transfers in one or more wire databases (which may be on the same or similar systems as the transaction database at the ACH transaction processing system), and compare the data against past wire transfer data. In an embodiment, wire transfer data may be more comprehensive in terms of accurate user information, because wire transfers typically have a fee associated therewith.

In various embodiments, once the verification of the submitted data is established at 330, the method may end. It may be appreciated that once verified, the submitted data may be relayed to the bank associated with the ABA number in the submitted data for processing. In some embodiments where the submitted data at the ACH transaction verifier includes sufficient data for the transaction to be processed, the submitted data may be relayed to the ACH transaction processing system for processing. In embodiments where the submitted data was sufficient for the transaction to be processed, and such sufficient data was relayed to the ACH transaction processing system when querying the transaction database, the ACH transaction verifier may instruct the ACH transaction processing system to proceed with processing that ACH transaction (e.g., by relaying confirmation instruction data to the ACH transaction processing system).

It may be appreciated that in some embodiments, timing of prior transactions in the transaction database may be considered by the ACH transaction verifier, and utilized in the weighting. For example, in an embodiment, if the most recent prior ACH transaction is greater than a threshold amount of time ago, the submitted data and the prior transaction data may be submitted for manual verification (e.g., by an employee at the ACH transaction verifier). Other mechanisms for handling “stale” prior transaction data are also possible in some embodiments, including but not limited to calculating an average interval between ACH transaction, and verifying based on the submitted data and the prior transaction data if the submitted ACH transaction is not otherwise following an unusually lengthy delay between transactions, or if the delay between the submitted ACH transaction and the immediate prior ACH transaction is typical of the delays between a plurality of prior ACH transactions. In various embodiments, the staleness of prior ACH transactions may be measured by a threshold amount of time (e.g., in months or years), or may be measured based on the relative nature of prior transactions to one another.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

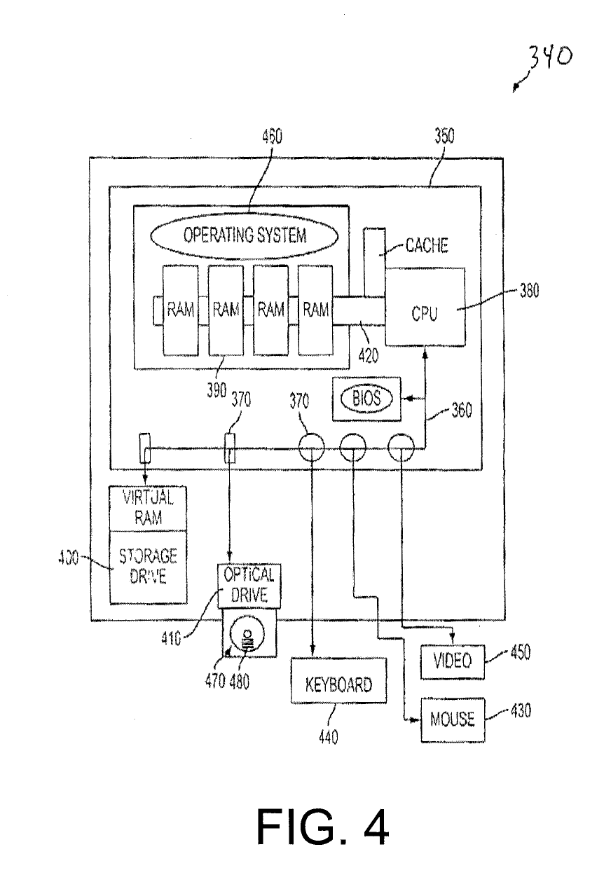

For example, FIG. 4 illustrates a high level block diagram of an exemplary computer system 340 which may be used to perform embodiments of the processes disclosed herein, including but not limited to process 290, and the ACH data reception and comparison functions of the ACH transaction verifier 120. It may be appreciated that in some embodiments, the system performing the processes herein may include some or all of the computer system 340. In some embodiments, the computer system 340 may be linked to or otherwise associated with other computer systems 340, including via the network 105. In an embodiment the computer system 340 has a case enclosing a main board 350. The main board has a system bus 360, connection ports 370, a processing unit, such as Central Processing Unit (CPU) 380, and a data storage device, such as main memory 390, storage drive 400, and optical drive 410. Each of main memory 390, storage drive 400, and optical drive 410 may be of any appropriate construction or configuration. For example, in some embodiments storage drive 400 may comprise a spinning hard disk drive, or may comprise a solid-state drive. Additionally, optical drive 410 may comprise a CD drive, a DVD drive, a Blu-ray drive, or any other appropriate optical medium.

Memory bus 420 couples main memory 390 to CPU 380. A system bus 460 couples storage drive 400, optical drive 410, and connection ports 370 to CPU 380. Multiple input devices may be provided, such as for example a mouse 430 and keyboard 440. Multiple output devices may also be provided, such as for example a video monitor 450 and a printer (not shown). In an embodiment, such output devices may be configured to display information regarding the processes disclosed herein, including but not limited to ACH transaction information, prior transaction details, check images, and so on. It may be appreciated that the input devices and output devices may alternatively be local to the computer system 340, or may be located remotely (e.g., interfacing with the computer system 340 through a network or other remote connection).

Computer system 340 may be a commercially available system, or may be proprietary design. In some embodiments, the computer system 340 may be a desktop workstation unit, and may be provided by any appropriate computer system provider. In some embodiments, computer system 340 comprise a networked computer system, wherein memory storage components such as storage drive 400, additional CPUs 380 and output devices such as printers are provided by physically separate computer systems commonly tied together in the network (e.g., through portions of the network 105). Those skilled in the art will understand and appreciate the physical composition of components and component interconnections comprising computer system 340, and select a computer system 340 suitable for performing the methods disclosed herein.

When computer system 340 is activated, preferably an operating system 460 will load into main memory 390 as part of the boot sequence, and ready the computer system 340 for operation. At the simplest level, and in the most general sense, the tasks of an operating system fall into specific categories—process management, device management (including application and user interface management) and memory management.

In such a computer system 340, the CPU 380 is operable to perform one or more methods of the systems, platforms, components, or modules described herein. Those skilled in the art will understand that a computer-readable medium 470, on which is a computer program 480 for performing the methods disclosed herein, may be provided to the computer system 340. The form of the medium 470 and language of the program 480 are understood to be appropriate for computer system 340. Utilizing the memory stores, such as one or more storage drives 400 and main system memory 390, the operable CPU 380 will read the instructions provided by the computer program 480 and operate to perform the methods disclosed herein.

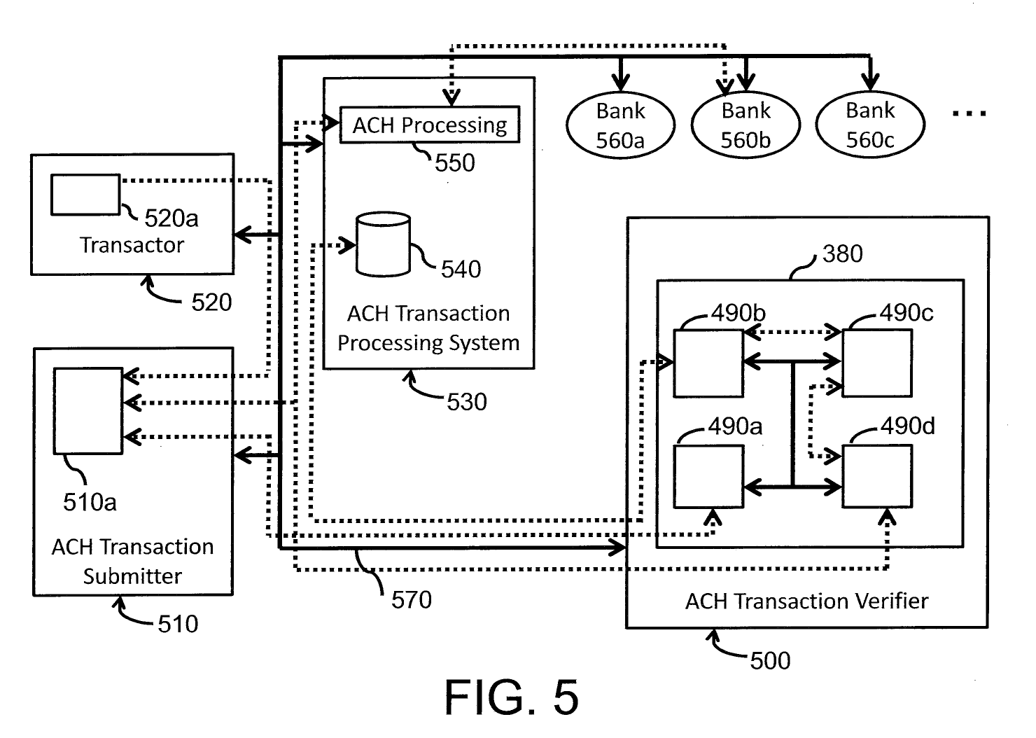

As shown in FIG. 5, in some embodiments an ACH transaction verifier 500 may include the CPU 380 (either alone or in conjunction with additional CPUs 380) therein, which may be configured to perform the ACH transaction verification processes described herein. In an embodiment the CPU 380 may be configured to execute one or more computer program modules 490, each configured to perform one or more functions of the systems, platforms, components, or modules described herein. For example, in the illustrated embodiment, at a CPU 380 operated by the ACH transaction verifier 500 (which may be analogous to the ACH transaction verifier 120), a computer program module 490a may be operatively linked to an ACH transaction submitter 510, which may be similar in configuration to the ACH transaction submitter 110. As described herein, the computer program module 490a may be configured to receive submitted ACH transaction submission 510a from the ACH transaction submitter 510. In an embodiment, the ACH transaction submission 510a may be received from a transactor 520, which may comprise a computer system having a user input 520a, at which a user may enter data for the ACH transaction submission 510a. As described in embodiments above, in various embodiments such a user input 520a may comprise a graphical user interface, a terminal interface, or any other appropriate mechanism for receiving the data for the ACH transaction submission 510a. It may be appreciated that similarly to the submission input 240 received at the ACH transaction submitter 110, in some embodiments the ACH transaction submission 510a may include account locator information 160 (e.g., ABA number 170 and an account number 180), which the ACH transaction verifier 500 may attempt to verify. The ACH transaction submission 510a may also include verification information 190, with which the ACH transaction verifier 500 may attempt to verify the account locator information 160.

In the illustrated embodiment, having received the ACH transaction submission 510a from the ACH transaction submitter 510, the CPU 380 may be configured, via a computer program module 490b to search prior transactions at an ACH transaction processing system 530 for transactions matching the ABA code and account number of the ACH transaction submission 510a. In particular, the computer program module 490b may query a transaction database 540 at the ACH transaction processing system 530 based on the ABA code and account number, and may receive prior transaction data for prior ACH transactions matching that ABA code and account number.

In an embodiment, upon receiving the prior transaction data, a computer program module 490c may compare the verification information 190 with analogous information in the prior transaction data received from the transaction database 540, as described in the embodiments above. If the computer program module 490c determines than the ACH transaction information 510 is verified (e.g., that the verification information 190 verifies the account locator information 160 as submitted by the transactor 520), then the CPU 380 may indicate the submitted transaction as verified. In an embodiment, a computer program module 490d may indicate the verification to the ACH transactions submitter 510, and/or may relay the ACH transaction submission to the ACH transaction processing system (e.g., to a processing module 550 thereof). It may be appreciated that the processing module 550 may be operatively linked to a plurality of banks 560 (e.g., similar to the banks 150 described above), and may relay the ACH transaction to a selected one of the banks 560 (e.g., the bank 560b in the illustrated embodiment of FIG. 5) based on the ABA number 170, for processing on the account at the bank 560b based on the account number 180.

In the illustrated embodiment, the CPU 380 and/or other systems at the ACH transaction verifier 500 is linked to one or more of the ACH transaction submitter 510, the transactor 520, the ACH transaction processing system 530, and the banks 560 via a network 570. As described above, in various embodiments disparate networks may be operatively linked between subsets of these systems, in a manner that facilitates receiving and transmission of relevant data to each of the components thereof for verification of the ACH transaction submissions. As such, the illustrated interconnections are merely exemplary, and other configurations are alternatively possible in other embodiments.

It may be appreciated that in an embodiment, one or more of the computer program modules 490 may be configured to transmit, for viewing on an electronic display communicatively linked with the one or more processors, a graphical user interface, which may be displayed on a display associated with one or more of the systems described herein. In an embodiment, the graphical user interface may be configured to receive data associated with that computer program module 490. In an embodiment, a separate computer program module 490 may be configured to generate and transmit the graphical user interfaces for each of a plurality of the computer program modules 490. Such graphical user interfaces may facilitate reception of the data in the user input 520a, may facilitate manual verification of account data when the likelihood of a match is not sufficiently high to warrant an automated match, or so on.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for verifying ACH data for a proposed ACH transaction, the system comprising one or more computer processors, at an ACH transaction verifier, the one or more computer processors configured to execute one or more computer program modules, the program modules being configured to:
receive, via the one or more processors, account locator information and verification information;
query, via the one or more processors, an ACH transaction database at an ACH transaction processing system with the account locator information to obtain prior transaction data associated with the account locator information;
compare, via the one or more processors, the verification information with the prior transaction data; and
determine, via the one or more processors, a verification of the account locator information based on the comparing.

2. The system of claim 1, wherein the account locator information comprises an ABA number and an account number.

3. The system of claim 1, wherein the verification information comprises one or more of a name, an address, a phone number, a password, a personal identification number, an e-mail address, and a code word.

4. The system of claim 1, wherein the ACH transaction processing system comprises one or more of the Electronics Payments Network operated by The Clearing House Payments Company L.L.C. and FedACH operated by the Federal Reserve.

5. The system of claim 1, wherein the one or more processors are configured to compare the verification information with the prior transaction data by generating an approximation of one or more of the verification information and the prior transaction data, and comparing the approximation with the verification information or the prior transaction data.

6. The system of claim 5, wherein generating the approximation of one or more of the verification information and the prior transaction data comprises omitting a portion of the verification information or the prior transaction data.

7. The system of claim 1, wherein the one or more processors are configured to determine the verification based on the comparing by determining a likelihood of a match between the verification information and the prior transaction data, and determining the account locator information as being verified if the likelihood of the match meets or exceeds a threshold amount.

8. The system of claim 7, wherein the threshold amount is 80%, such that if the likelihood of the match is greater than or equal to approximately 80%, the account locator information is determined to be verified.

9. The system of claim 7, wherein if the likelihood of the match is less than the threshold amount, the one or more processors are configured to advance the proposed ACH transaction for further analysis to attempt to verify the account locator information.

10. The system of claim 9, wherein the further analysis comprises one or more of performing optical character recognition on a prior check associated with the prior transaction data, comparing the verification information with wire transfer information associated with the prior transaction data, and presenting the verification information and the prior transaction data to a user at the ACH transaction verifier for manual verification.

11. A computer implemented method for verifying ACH data for a proposed ACH transaction, wherein the method is implemented in a computer system comprising one or more processors configured to execute one or more computer program modules, the method comprising:
receiving, via the one or more processors, account locator information and verification information;
querying, via the one or more processors, an ACH transaction database at an ACH transaction processing system with the account locator information to obtain prior transaction data associated with the account locator information;
comparing, via the one or more processors, the verification information with the prior transaction data; and
determining, via the one or more processors, a verification of the account locator information based on the comparing.

12. The method of claim 11, wherein the account locator information comprises an ABA number and an account number.

13. The method of claim 11, wherein the verification information comprises one or more of a name, an address, a phone number, a password, a personal identification number, an e-mail address, and a code word.

14. The method of claim 11, wherein the ACH transaction processing system comprises one or more of the Electronics Payments Network operated by The Clearing House Payments Company L.L.C. and FedACH operated by the Federal Reserve.

15. The method of claim 11, wherein comparing the verification information with the prior transaction data comprises generating an approximation of one or more of the verification information and the prior transaction data, and comparing the approximation with the verification information or the prior transaction data.

16. The method of claim 15, wherein generating the approximation of one or more of the verification information and the prior transaction data comprises omitting a portion of the verification information or the prior transaction data.

17. The method of claim 11, wherein determining the verification based on the comparing comprises determining a likelihood of a match between the verification information and the prior transaction data, and determining the account locator information as being verified if the likelihood of the match meets or exceeds a threshold amount.

18. The method of claim 17, wherein the threshold amount is 80%, such that if the likelihood of the match is greater than or equal to approximately 80%, the account locator information is determined to be verified.

19. The method of claim 17, wherein if the likelihood of the match is less than the threshold amount, the one or more processors are configured to advance the proposed ACH transaction for further analysis to attempt to verify the account locator information.

20. The method of claim 19, wherein the further analysis comprises one or more of performing optical character recognition on a prior check associated with the prior transaction data, comparing the verification information with wire transfer information associated with the prior transaction data, and presenting the verification information and the prior transaction data to a user at the ACH transaction verifier for manual verification.
